(19) United States
(12) Patent Application Publication
(10) Pub. No.: US 2025/0388335 A1
(43) Pub. Date: Dec. 25, 2025

(54) CABLE INTERCONNECTION SUPPORT FOR AERONAUTICAL EQUIPMENT

(71) Applicant: Airbus Operations SAS, TOULOUSE (FR)

(72) Inventor: Benjamin BOISNIER, TOULOUSE (FR)

(21) Appl. No.: 19/246,088

(22) Filed: Jun. 23, 2025

(30) Foreign Application Priority Data
Jun. 24, 2024 (FR) FR2406747

(51) Int. Cl. B64D 47/00; H02G 3/32

(52) U.S. Cl. CPC B64D 47/00; H02G 3/32; B64D 2221/00

(57) ABSTRACT

A cable interconnection support, notably for an aircraft, including a base conformed to receive a cable interconnection module and at least one element for retaining cables rigidly connected to the base. Also a cable interconnection device with the support and interconnection module accommodated in the base, and a system with two cable interconnection devices fixed to each other. Also an aircraft with such a cable interconnection support.

### CROSS-REFERENCES TO RELATED APPLICATIONS

This application claims the benefit of French Patent Application Number FR2406747 filed on Jun. 24, 2024, the entire disclosure of which is incorporated herein by way of reference.

### FIELD OF THE INVENTION

The present invention relates to a cable interconnection support for equipment, notably equipment in the aeronautical field.

### BACKGROUND OF THE INVENTION

Because of its complexity an aircraft is fitted with a very large number of electrical cables and modules for interconnecting the electrical cables. Such modules take the form of blocks pierced by housings, each housing being able to receive a dedicated electrical cable. The modules are generally fixed to rails themselves fixed to an equipment unit of the aircraft and the cables that they carry are connected to a nearby bundle of cables.

Such a known arrangement has the disadvantage of necessitating a plurality of parts and being bulky, and it can therefore prove difficult, time-consuming and costly to integrate the interconnection modules in the environment for which they are intended, and in particular at a short distance from the bundle of cables to which they must be connected. Over and above this, the cables can become tangled, or even bent and damaged, preventing the electrical circuits from functioning correctly.

The aim of the invention is to remedy at least some of these disadvantages.

### SUMMARY OF THE INVENTION

To this end there is proposed a cable interconnection support, notably for an aircraft, including a base conformed to receive at least one cable interconnection module and at least one element for retaining said cables rigidly connected to said base.

Thanks to the support according to the present invention it is therefore possible to match the base to the cable interconnection modules and to fix the module in the appropriate environment at the most appropriate location, that is to say to integrate a simple and relatively low-cost cable interconnection module optimally while ensuring the cables are retained in the required position.

According to another aspect the support includes at least one element for holding said cables substantially orthogonal to said base.

According to another aspect the support includes means for clipping the module into the support.

According to another aspect the base includes an opening.

According to another aspect the support includes a support anti-rotation element.

According to another aspect the support includes a member for rigidly connecting the support to another support.

According to another aspect the rigid connection member includes a male engagement element and an element adapted to receive said male engagement element.

In accordance with another aspect the at least one male engagement element and the element adapted to receive said male engagement element is conformed to retain a cable tie.

According to another aspect the support includes at least one support fixing lug.

The invention also has for object a cable interconnection device including a support as described above and at least one cable interconnection module housed in the base of the support.

The invention also has for object an assembly of cable interconnection devices including at least one first cable interconnection support as described above, a cable interconnection module being housed in the base of said first cable interconnection support, and a second cable interconnection support as described above, a cable interconnection module being housed in the base of said second cable interconnection support, said first support and said second support being fixed to one another by the rigid connection members.

The invention also has for object an aircraft including a cable interconnection support as described above.

### BRIEF DESCRIPTION OF THE DRAWINGS

Other features, details and advantages will become apparent on reading the following detailed description and analyzing the appended drawings, in which:

FIG. 1 is a diagrammatic perspective view of a cable interconnection support in accordance with a first embodiment of the invention, a cable interconnection module ready to be housed in it also being represented;

FIG. 2 is another diagrammatic perspective view of the support from FIG. 1;

FIG. 3 is a diagrammatic perspective view of a cable of an interconnection device including the support and the module from FIG. 1 fixed to a main cable sheath;

FIG. 4 is a diagrammatic perspective view of a cable interconnection support in accordance with a variant embodiment of the invention;

FIG. 5 is a diagrammatic perspective view of a cable interconnection support in accordance with a second embodiment of the invention;

FIG. 6 is a diagrammatic perspective view of an interconnection device including the support from FIG. 5 and two cable interconnection modules fixed near a main cable;

FIG. 7 is a diagrammatic perspective view of an assembly comprising two interconnection devices each including an interconnection module and a support from FIG. 1 in a position before rigid connection of the two devices to one another, the electrical cables not being represented; and,

FIG. 8 is a diagrammatic view of the assembly from FIG. 7 in a position in which the two devices are rigidly connected to one another, the electrical cables not being represented.

### DETAILED DESCRIPTION OF THE PREFERRED EMBODIMENTS

The examples and the associated conditions described in detail here are mainly intended to assist the reader to understand the principles of the present invention and not to limit its scope to those specific examples and conditions. It will be clear that the person skilled in the art can conceive of various arrangements which although they are not explicitly described or represented here nevertheless embody the principles of the present invention and are included within its scope.

Furthermore, to facilitate understanding it the following description may describe relatively simplified embodiments of the present invention. As the person skilled in the art understands other embodiments of the present invention can be of greater complexity.

In some cases examples of modifications of the present invention may also be described. This is merely as an aid to understanding and again not to define the scope of or to establish the limits of the present invention. These modifications do not form an exhaustive list and the person skilled in the art can make other modifications while remaining within the scope of the present invention.

Furthermore, all declarations hereinafter relating to the principles, aspects and embodiments of the present invention as well as the specific examples of the latter aim to encompass structural and functional equivalents thereof whether known at present or developed in the future.

As emerges from the figures, the invention has for an object a support 1 for interconnecting electrical cables C. This can also be referred to as a gantry 1. The support 1 is intended to house at least one electrical cable interconnection module. The invention also has for an object a device 2 including the support 1 and at least one module M.

Each module includes a block 3 of parallelepipedal general shape for example including electrical cable passage orifices 4 on one face F, each orifice 4 being adapted to receive an electrical cable C.

As also emerges from the figures the support 1 includes a base 5 and an element 6 for retaining the cables C. The support 1 is intended to be suspended against an equipment unit, for example a main cable 7, to which the cables C must be connected, or fixed near the latter. Note that the main cable 7 is advantageously of circular or at least curved section.

The element 6 includes at least one lug 8 described in detail hereinafter.

As described in detail hereinafter the base 5 is conformed to receive a single module (first embodiment) or a plurality of modules. Each module is placed on the base 5, a face opposite the face F resting on the base 5.

The base 5 has a flat parallelepiped general shape. A main plane of the base 5 is defined as the main plane in which the base 5 extends, referenced P in the figures.

The base 5 is preferably part of a platform 9 having at least one side 10 adapted to retain each module in the support 1.

The platform 9 includes at least one means 11 for clipping the module into the support 1.

The support 1 advantageously also includes an anti-rotation element 12.

As described in detail hereinafter the support 1 advantageously includes means 13 for rigidly connecting the support 1 to another support.

As also described in detail hereinafter the support 1 advantageously includes at least one fixing lug 14.

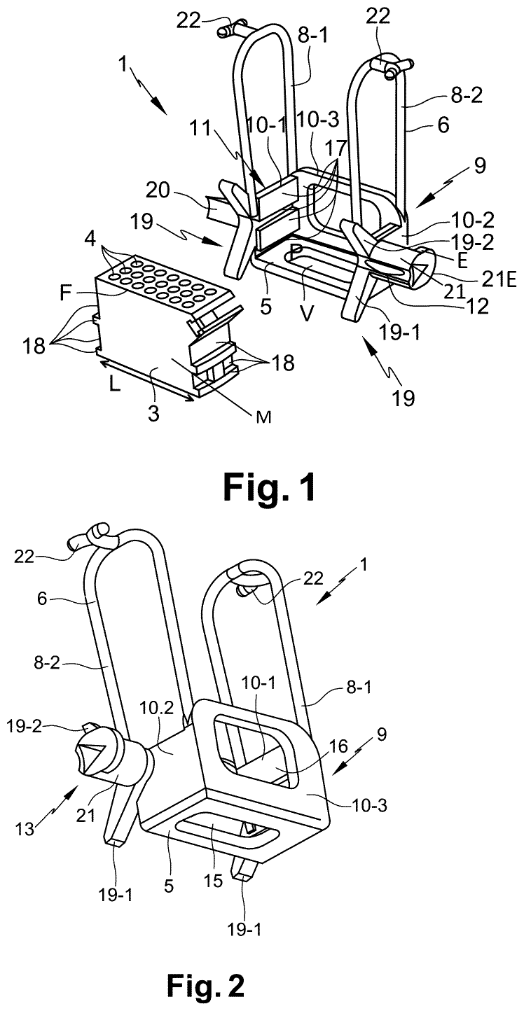

The first embodiment is described next with reference to FIGS. 1 to 4.

In FIGS. 1 to 4 the platform 9 includes three retaining sides, two end sides 10-1, 10-2 and a junction side 10-3 joining the two end sides 10-1, 10-2. Each retaining side is a wall.

The retaining sides 10-1, 10-2, 10-3 are substantially (i.e., +/−10%) orthogonal to the base 5 and form a U shape. The two end sides 10-1, 10-2 face and are parallel to one another. A volume V adapted to receive the module is therefore delimited by the platform 9 between the base 5 and the retaining sides 10-1 to 10-3.

In accordance with this first embodiment the volume V matches the dimensions of a module. In other words, the support 1 receives only one module. Nevertheless, the invention is not limited to this embodiment and a platform accommodating a plurality of modules M can be envisaged.

As can be seen in FIGS. 1 to 4 the base 5 and the junction side 10-3 each include a central opening 15, 16 whereas the end sides 10-1, 10-2 are solid. The openings 15, 16 advantageously reduce the weight of, increase the flexibility of and where applicable cool the module. Nevertheless, the invention is not limited to this embodiment and the base 5 and/or the side 10-3 being solid and/or the sides 10-1, 10-2 including openings can be envisaged.

As can be seen particularly in FIG. 1 the end sides 10-1, 10-2 carry the clipping means 11 in the form of grooves/ribs 17 in which complementary ribs/grooves 18 of the block 3 slide.

The platform 9 includes a grip 19 at each end side 10-1, 10-2. Each grip 19 includes two bars 19-1, 19-2 in a V arrangement at an obtuse angle, for example 120°. As described in detail hereinafter the bars are intended to be placed against the main cable 7.

In accordance with this first embodiment the rigid connecting means 13 make a male-female type connection. The means 13 include on the one hand a male engagement element 20 and a cylinder 21 with an opening of complementary shape to the male engagement element 20. The male engagement element 20 projects from the end side 10-1 whereas the cylinder 21 projects from the end side 10-2. The cylinder 21 is intended to be placed on the sheath of the main cable 7.

The cylinder 21 includes a body that extends between an end rigidly connected to the platform 9 and a free end 21E. The free end 21E has a diameter larger than that of the body of the cylinder 21, which creates a shoulder E on the cylinder 21. The shoulder E makes it possible to retain a cable tie 23 as described in detail hereinafter.

The male engagement element 20 has a main surface 20p and a head 20t inclined relative to the main surface 20p. The main surface 20p is preferably curved to espouse the shape of the equipment unit, for example the sheath, which is preferably circular, against which it is intended to be in contact. The inclination of the head 20t makes it possible to retain a cable tie as described in detail hereinafter.

In accordance with this first embodiment the anti-rotation element 12 is an aileron rigidly connected to the cylinder 21, which prevents the device 2 from pivoting when the cylinder is placed on the sheath of the main cable 7.

Note that like the element 20 the cylinder 21 includes a curved surface intended to come up against the cable for improved retention.

As also depicted in the figures the support 1 includes two lugs 8-1, 8-2 facing one another. Each lug 8-1, 8-2 includes an inverted U attached on the one hand to the junction side 10-3 and to one of the end sides 10-1, 10-2, respectively. The lugs are orthogonal to the main plane of the base 5. At the top of each U shape the lug 8-1, 8-2 includes a Y-shaped pin 22 for a cable tie to pass around as described in detail hereinafter. Alternatively, the pin 22 can be T-shaped for example. The Y-shape or T-shape of the pins 22 enables retention of the cable ties 23.

In accordance with a variant embodiment depicted in FIG. 4 the support 1 includes two fixing lugs 14 rigidly connected to the base 5. Each lug includes an orifice for inserting a screw.

To obtain the device 2 based on the support 1 see FIG. 1. As emerges from that figure it suffices to insert the block 3 in the platform 9 and the ribs/grooves 17 of the end sides 10-1, 10-2 and the grooves/ribs 18 of the associated block 3 clip the module into the support 1.

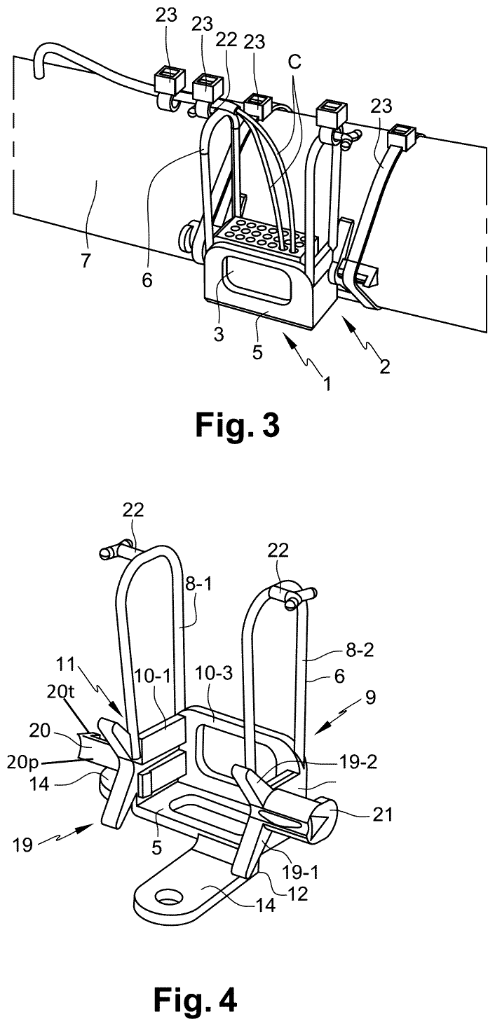

To install the device 2 in the aircraft see FIG. 3. As emerges from that figure the device 2 is placed against the sheath of the main cable 7. The ends of the bars 19-1, 19-2 of the grips 19 are then in contact with the main cable 7 and likewise the male engagement element 20 and the female cylinder 21. The electrical cables C are held high up against the pins 22 by cable ties 23 which ensures that the cables are not bent but to the contrary kept straight where they exit the orifices 4. The direction of the cables perpendicular to the base 5 prevents damage to the cables C. Other cable ties 23 in FIG. 3 for example are respectively passed around the male engagement element 20 and the female cylinder 21 to suspend the device 2 from and to attach it to the main cable 7.

Because it is compact (given that it has the dimensions of the block 3) and suspended by cable ties the device 2 enables the cables C to be positioned as close as possible to the main cable 7. Recourse to the cable ties 23 ensures simple, easy, fast and secure fixing of the device 2 to the main cable 7. Over and above this, the positioning and height of the cable C at the top of the lugs 8 prevents deterioration of the electrical cables. Additionally, clipping the blocks into the base 5 enables both rapid and simple insertion of the modules M in the support 1 and facilitates replacement thereof if the modules M have to be changed, for example.

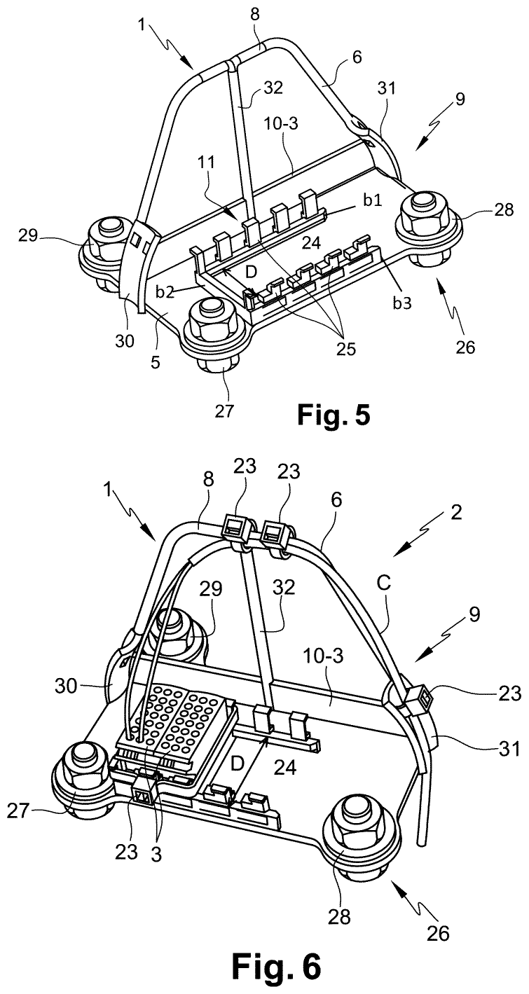

The second embodiment is described next with reference to FIGS. 5 and 6.

In FIGS. 5 and 6 the platform 9 includes a wall 10-3 referred to as the retaining side 10-3.

In accordance with this embodiment the base 5 includes a zone 24 for housing one or more modules M. The zone 24 is delimited by three strips b1, b2, b3 forming a U shape and surmounted by two rows of flexible lugs 25 forming the clipping means 11. The two rows are spaced by a distance D. The lugs 25 are preferably perpendicular to the base 5. The distance D coincides with a length L of the block 3. In FIGS. 5 and 6 two blocks 3 have been installed, the zone 24 being able to accept up to four blocks 3. Nevertheless, the invention is not limited to this arrangement and the zone 24 can house a single block or more than four blocks, depending on the electrical circuits of the aircraft.

In accordance with the second embodiment the volume V delimited by the platform 9 between the base 5 and the retaining side 10-3 is larger than the zone 24. Nevertheless, the invention is not limited to this embodiment and the base 5 matching the zone 24 can be envisaged.

As can be seen in FIGS. 5 and 6 the support 1 includes a set 26 of three fixing means 27, 28, 29 for fixing the platform 9 to an equipment unit of the aircraft. The equipment unit is for example trunking in which the sheath of the main cables 7 circulates. The fixing means 27, 28 are disposed at the ends of the length of the base 5 opposite the retaining side 10-3 whereas the fixing means 29 are disposed on the other side of the retaining side 10-3, extending the base 5. The fixing means 27 and 28 also prevent rotation of the support 1. The fixing means 27, 28, 29 are for example grips that enable attachment thereto.

Of course, the invention is not limited to this arrangement and any type of attachment suitable for the environment in which the module must be installed can be envisaged.

As also depicted in FIGS. 5 and 6 the element for retaining the cables C includes an inverted U-shape lug 8 the ends 30, 31 of which are rigidly connected to respective ends of the retaining side 10-3. The lug 8 may include a reinforcing rod 32 between the top of the U shape and the middle of the retaining side 10-3. Depending on the dimensions and the size of the base 5 the arms of the lugs 8 can diverge (they are not parallel). Each end 30, 31 includes a curved wall on which the cable C is intended to be positioned, enabling facilitated sliding of the cables C, advantageously provided with two through-holes for a cable tie 23, the tie enabling the cable C to be retained against the wall. The lug 8 is orthogonal to the main plane of the base 5, which prevents damaging the cables C, as described hereinafter.

To obtain the device 2 based on the support 1 see FIG. 6. As emerges from that figure it suffices to insert the block 3 in the platform 9 by moving apart the lugs 25 that clip the module into the support 1. A cable tie 23 is then tightened around the blocks 3.

For positioning the device 2 in the aircraft see FIG. 6. As emerges from that figure the device 2 is fixed near the sheath of the main cable 7 by means of the fixing means 27, 28, 29. The electrical cables C are held high up by one or more cable ties 23 at the top of the lug 8, which ensures that the cables are not bent but remain straight on leaving the orifices 4 of the blocks 3. The direction of the cables perpendicular to the base 5 prevents damaging the cables C. In FIG. 6 other cable ties 23, for example a tie on the wall at end 31, are used to guide and retain the cables C as far as the sheath thereof.

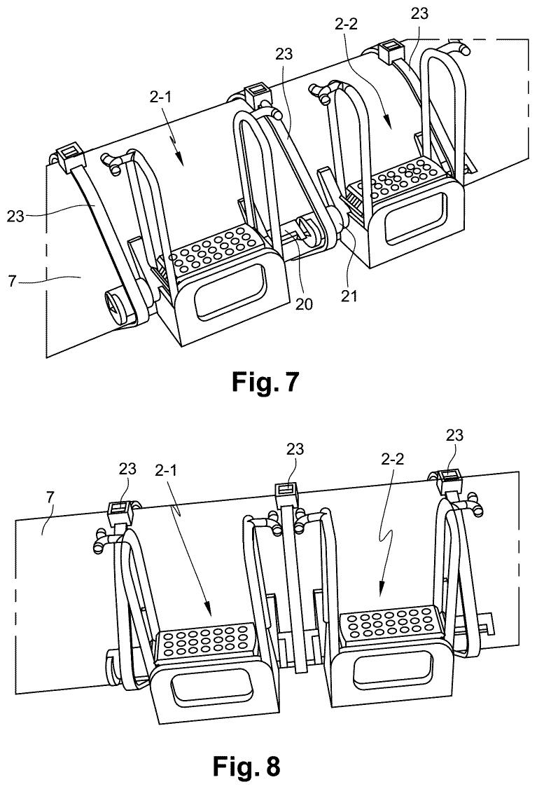

Because it is compact (given that it is only slightly larger than the dimensions of a plurality of blocks 3) and fixed near the sheath, the device 2 therefore enables positioning of the cables C as close as possible to the main cable 7. Over and above this the height-wise positioning of the cable C at the top of the lug 8 prevents deterioration of the electrical cables. Recourse to cable ties 23 also ensures simple, easy, rapid and secure fixing of the cables C and the blocks 3 to the support 1. Additionally, clipping the blocks into the base 5 enables both rapid and simple insertion of the modules M in the support 1 and facilitates replacing them if the modules M have to be changed, for example. Refer now to FIGS. 7 and 8.

In those figures two devices 2-1, 2-2 in accordance with the first embodiment are rigidly connected.

As can be seen, each device 2 is suspended from the sheath of the main cable 7 by cable ties 23 respectively around the male engagement elements 20 and the cylinders 21.

In FIG. 7 the male engagement element 20 of the device 2-1 is disposed facing the cylinder 21 of the device 2-2, in line with the latter. It then suffices to insert the male engagement element 20, e.g., a rod, in the opening of the cylinder 21 to assemble and lock the devices 2-1 and 2-2.

In accordance with the first embodiment, if a plurality of blocks 3 are necessary it therefore suffices to assemble a plurality of devices 2 together along the sheath.

The support 1 according to the present invention represents flexible fixing means that adapt to the space in which the interconnection modules must be mounted and to the electrical circuits, depending on the number of blocks 3 necessary.

Modifications and improvements to the embodiments of the present invention described hereinabove may become apparent to the person skilled in the art. In particular, the embodiments can be combined as long as they are not incompatible.

The description hereinabove is illustrative by means of examples rather than limitative. The scope of the present invention is therefore limited only by the scope of the following claims.

While at least one exemplary embodiment of the present invention(s) is disclosed herein, it should be understood that modifications, substitutions and alternatives may be apparent to one of ordinary skill in the art and can be made without departing from the scope of this disclosure. This disclosure is intended to cover any adaptations or variations of the exemplary embodiment(s). In addition, in this disclosure, the terms “comprise” or “comprising” do not exclude other elements or steps, the terms “a” or “one” do not exclude a plural number, and the term “or” means either or both. Furthermore, characteristics or steps which have been described may also be used in combination with other characteristics or steps and in any order unless the disclosure or context suggests otherwise. This disclosure hereby incorporates by reference the complete disclosure of any patent or application from which it claims benefit or priority.

Claimed is:

1. A cable interconnection support for an aircraft comprising:
a base configured to receive a cable interconnection module; and
at least one element for retaining cables rigidly connected to said base.

2. The cable interconnection support according to claim 1, wherein said at least one element for retaining said cables extends substantially orthogonally to said base.

3. The cable interconnection support according to claim 1, further comprising:
means for clipping the cable interconnection module into the cable interconnection support.

4. The cable interconnection support according to claim 1, further comprising:
a rigid connection member configured for rigidly connecting the cable interconnection support to another support.

5. The cable interconnection support according to claim 4, wherein the rigid connection member comprises a male engagement element and an element configured to receive said male engagement element.

6. The cable interconnection support according to claim 5, wherein the male engagement element, the element adapted to receive said male engagement element, or both are configured to retain a cable tie.

7. The cable interconnection support according to claim 1, further comprising:
at least one lug for fixing the cable interconnection support.

8. A cable interconnection device comprising:
the cable interconnection support according to claim 1; and
at least one cable interconnection module accommodated in the base of the cable interconnection support.

9. An assembly of cable interconnection devices comprising:
at least two cable interconnection support according to claim 4, a first cable interconnection support and a second cable interconnection support fixed to one another by a rigid connection member.

10. An aircraft comprising:
the cable interconnection support according to claim 1.
